(19) United States
(12) Patent Application Publication
(10) Pub. No.: US 2014/0167943 A1
(43) Pub. Date: Jun. 19, 2014

(54) WIRELESS PROGRAMMABLE CLUSTER

(71) Applicant: Continental Automotive Systems, Inc., Auburn Hills, MI (US)

(72) Inventor: Matt Zelik Jonatán Chávez Yanez, Tlaquepaque (MX)

(73) Assignee: Continental Automotive Systems, Inc., Auburn Hills, MI (US)

(21) Appl. No.: 14/107,015

(22) Filed: Dec. 16, 2013

Related U.S. Application Data
(60) Provisional application No. 61/738,445, filed on Dec. 18, 2012.

(51) Int. Cl. B60K 37/02

(52) U.S. Cl. CPC B60K 37/02
USPC 340/438

(57) ABSTRACT

A disclosed instrument cluster assembly for a motor vehicle includes a plurality of instruments for displaying information indicative of a vehicle operating parameter, at least one memory device for storing data utilized for generating information indicative of vehicle operating parameters and a controller in communication with the plurality instruments and the at least one memory device for controlling operation and display of information indicative of the vehicle operating parameter. A wireless communication device is included and is in communication with both the controller and memory device for receiving data through a wireless connection that is utilized by one of the controller and the at least one memory device for generating information indicative of vehicle operating parameters.

### CROSS REFERENCE TO RELATED APPLICATION

This application claims priority to U.S. Provisional Application No. 61/738,445 filed on Dec. 18, 2012.

### TECHNICAL FIELD

The present disclosure relates to vehicle instrument panels and clusters, and more specifically to vehicle instrument cluster that is reconfigurable though a wireless programming interface.

### BACKGROUND

Vehicles include instrument panels to communicate information indicative of operation to an operator. Motor vehicles include instrument panels with several gauges and dials that communicate vehicle conditions such as speed, engine rpm, temperature, oil pressure along with many other operational parameters. Instrument panels and gauges include microcontrollers and memory devices for controlling information displayed by the gauges and displays. The data stored in the memory devices can include values that provide for the display of standard or metric values. Data stored in the memory may also include information used to determine the remaining range for a vehicle, current fuel efficiency and average fuel efficiency.

Typically such values are programmed during initial assembly and installation through an interface on the circuit board supporting the controller and memory device. In some instances, the information provided in the memory is required to be updated or reprogrammed. Such reprogramming can be required due to updated values or to change between standard and metric values. Once the instrument panel is installed within a vehicle, it is difficult to access the circuit board for reprogramming Moreover, access through the vehicle systems can add a further level of complexity and difficulty.

Accordingly, it is desirable to design and develop an instrument cluster and method of programming an instrument cluster that simplifies reprogramming and/or updating of a vehicle instrument cluster.

### SUMMARY

A disclosed instrument cluster assembly for a motor vehicle includes a plurality of instruments for displaying information indicative of a vehicle operating parameter, at least one memory device for storing data utilized for generating information indicative of vehicle operating parameters and a controller in communication with the plurality instruments and the at least one memory device for controlling operation and display of information indicative of the vehicle operating parameter. A wireless communication device is included and is in communication with both the controller and memory device for receiving data through a wireless connection that is utilized by one of the controller and the at least one memory device for generating information indicative of vehicle operating parameters.

The disclosed instrument panel assembly is reprogrammed utilizing a wireless transmission including data utilized for generating information indicative of a vehicle operating parameter and storing the data utilized for generating information indicative of the vehicle operating parameter in a memory device in communication with the instrument cluster assembly. The wireless reprogramming provides for updating and correction of information utilized for generating data indicative of vehicle operation without a hardwire connection.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example instrument panel for a motor vehicle.

FIG. 2 is a schematic view of programming steps for the example instrument panel.

### DETAILED DESCRIPTION

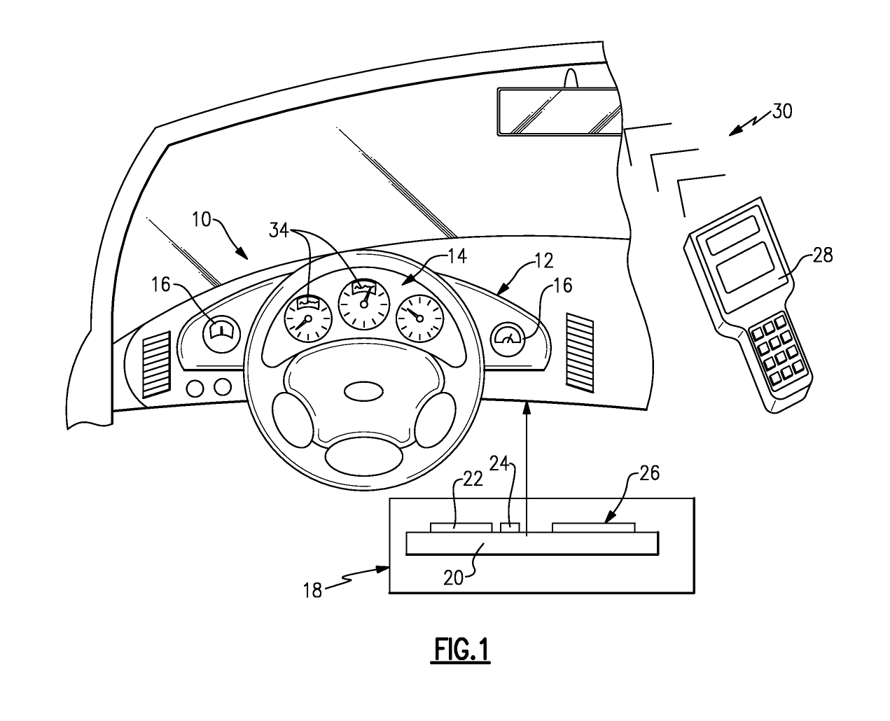

FIG. 1 schematically illustrates a dashboard 10 for a motor vehicle. The dashboard 10 includes an instrument panel 12 that includes a plurality of instruments for communicating information indicative of a vehicle operating parameter. In this example the instruments include primary gauge 14 and secondary gauges 14. The gauges 14, 16 communicate information indicative of vehicle operating parameters to vehicle operator. In this example, a digital display 34 is included in at least some of the primary and secondary gauges 14, 16 include a digital display for displaying selectable information separate from the gauge itself. Such data may include for example current and average fuel efficiency, remaining range along with any other data that can be determined utilizing data gathered by sensors within the vehicle. The calculations and formulas required for generating the values are stored within a controller 18 supported within the instrument panel 12. The calculations utilize formulas and constant information stored within a memory device 22.

The memory device 22 in this example is an electrically erasable read only memory device referred to as an EEPROM. It should be appreciated, that although an EEPROM is disclosed by way of example, the use of other reprogrammable memory devices are within the contemplation of this disclosure. Data is stored into the EEPROM 22 during initial production to provide the data required for a specific vehicle. For example, for a vehicle operating in a region where the metric system is employed, the data stored in the EEPROM provides the constants and formulas required to generate information in kilometers and liters. Those instrument panels 12 that are intend for use in regions where the standard system is utilized includes information to generate information in miles and gallons. In some instances, the initial programming and data requires updating either to provide an improved formulation or to accommodate a change in the intended operating range.

The initial programming is facilitated through a hardwire connection because the controller 18 and printed circuit board 20 are easily accessible prior to installation within a vehicle or shipping container. However, once the instrument panel 12 is installed within a vehicle or mounted within a shipping container, access becomes much more cumbersome and undesirable. The example instrument panel 12 includes a controller 18 with a wireless interface 24 and an antenna 26 for receiving radio frequency RF signals 20 from a transmitter 28 to perform flash reprogramming of the EEPROM without a hard wired connection.

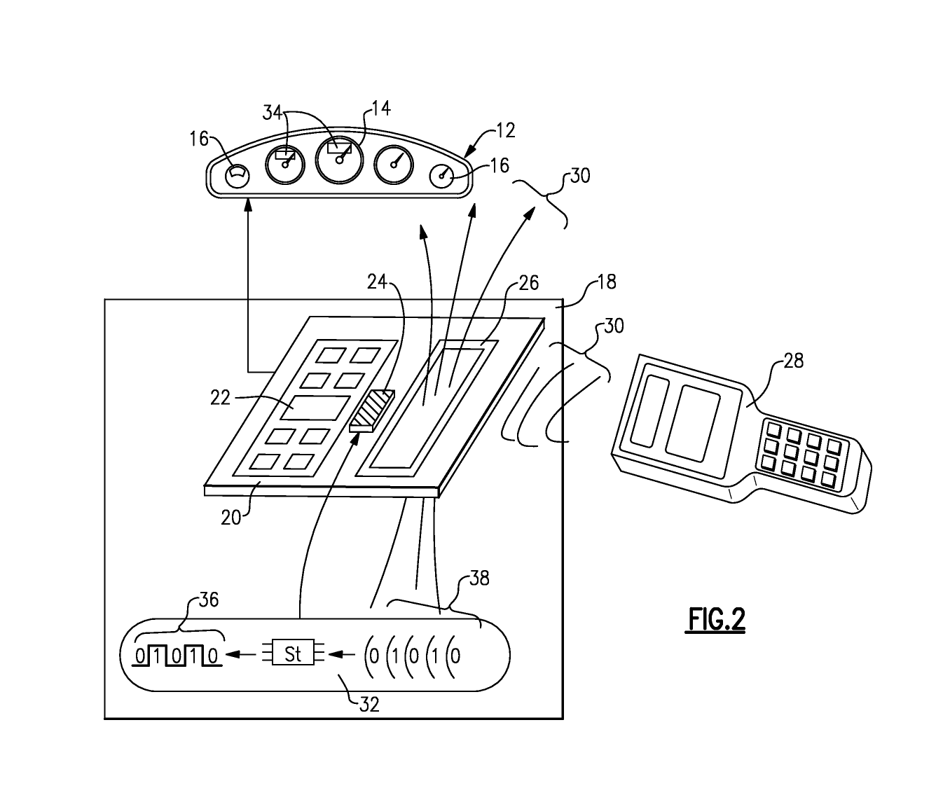

Referring to FIG. 2, with continued reference to FIG. 1, an example system including the transmitter 28 and instrument panel 12 for reprogramming is schematically shown. The example controller 18 includes the EEPROM 22 that is in communication with a wireless interface 24. The wireless interface 24 operates as schematically shown at 32 to receive data 38 from the RF signal 30 transmitted by a remote transmitter 28. The antenna 26 is a wire trace that is integrally formed as part of the printed circuit board 20. As appreciated, it is within the contemplation of this disclosure to utilize other antennas and locations capable of receiving the RF signal 30.

The wireless interface 24 translates the data 38 from the RF signal 30 into a form schematically indicated at 36 utilized by the EEPROM 22. That data is then stored for use by the controller 18 in generating data displayed by the digital displays 34, and/or gauges 14, 16. Transmissions by the transmitter 28 are received, converted to the form required by the EEPROM 22 or other integrated circuit utilizing the data and stored for use during vehicle operation. The wireless flash reprogramming of the EEPROM 22 enables reprogramming of instrument clusters without difficult and cumbersome disassembly to access the controller 18.

Accordingly, the instrument cluster 12 that is originally programmed to display information such as speed in kilometers/hour can be reprogrammed to display the information in miles/hour. In another example, calculations that utilize specific constants to generate information such as remaining range and vehicle fuel efficiency can be updated without require a physical hardware connection.

Additionally, although the example illustrates flash reprogramming of a single instrument panel, the same signal 30 could be utilized to flash reprogram several instrument panels within a specific range. Such flash reprogramming of a plurality of instrument clusters could be utilized to reprogram an entire lot or shipment of instrument panels either to correct or update the date utilized for generating vehicle information.

Accordingly, the example instrument panel 12 and method enables updating and/or reprogramming of integrated circuits controlling operation without a hardware connection.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. A method of programming an instrument cluster assembly comprising:
receiving a wireless transmission including data utilized for generating information indicative of a vehicle operating parameter; and
storing the data utilized for generating information indicative of the vehicle operating parameter in a memory device in communication with the instrument cluster assembly.

2. The method as recited in claim 1, including transmitting a radio frequency transmission including the data with a programming device physically separated from the instrument cluster assembly.

3. The method as recited in claim 1, including erasing existing data stored in the memory device responsive to a command received as a wireless signal.

4. The method as recited in claim 1, including a controller a communicating with a plurality of instruments of the instrument cluster assembly for generating information indicative of vehicle operating parameters utilizing the data received from the wireless transmission.

5. The method as recited in claim 4, including an interface between an antenna receiving the data and a memory device, wherein the interface generates signals utilized by an integrated circuit of the controller from the data received through the wireless transmission.

6. The method as recited in claim 5, wherein the memory device includes an electrically erasable programmable read only memory and the wireless transmission comprises a radio frequency transmission.

7. The method as recited in claim 6, including converting the radio frequency signal with the interface to information in a form compatible with the memory device.

8. The method as recited in claim 7, including flash reprogramming a previously programmed memory device through a radio frequency signal that includes data utilized for generating information indicative of a vehicle operating parameter.

9. The method as recited in claim 8, wherein the instrument cluster assembly comprises a plurality of instrument cluster assemblies with a corresponding plurality of memory devices and flash reprogramming the plurality of memory devise with the radio frequency signal.

10. An instrument cluster assembly comprising:
a plurality of instruments for displaying information indicative of a vehicle operating parameter;
at least one memory device for storing data utilized for generating information indicative of vehicle operating parameters;
a controller in communication with the plurality instruments and the at least one memory device for controlling operation and display of information indicative of the vehicle operating parameter; and
a wireless communication device for receiving data through a wireless connection that is utilized by one of the controller and the at least one memory device for generating information indicative of vehicle operating parameters.

11. The instrument cluster assembly as recited in claim 10, wherein the controller comprises a printed circuit board that includes a radio frequency antenna for receiving the data utilized for generating information indicative of vehicle operating parameters.

12. The instrument cluster assembly as recited in claim 11, wherein the wireless communication device includes a receiver for receiving a radio frequency transmission including the data and an interface for converting the data from the radio frequency transmission into a form stored in the memory device and utilized by the controller.

13. The instrument cluster assembly as recited in claim 11, wherein the antenna comprises a trace integrally formed on the printed circuit board.

14. The instrument cluster assembly as recited in claim 11, wherein the printed circuit board is supported within the instrument cluster assembly.

15. The instrument cluster assembly as recited in claim 10, wherein the data includes information utilized for determining the units of the information indicative of a vehicle operating parameter.

16. The instrument cluster assembly as recited in claim 15, wherein the data includes information utilized for generating a value indicative of a vehicle operating parameter.

17. A system for flash reprogramming an instrument cluster assembly comprising:
an instrument cluster assembly including a plurality of instruments for communicating information indicative of a vehicle operating parameter;
an electronically erasable read only memory (EEPROM) device supported within an instrument cluster assembly;
a controller in communication with the plurality instruments and the EEPROM; and
a wireless interface receiving a radio frequency RF signal including data stored in the EEPROM and utilized by the controller for generating information indicative of vehicle operating parameters.

18. The system as recited in claim 17, including a transmitting device for transmitting the RF signal for flash reprogramming the EEPROM.

19. The system as recited in claim 17, wherein the wireless interface includes an antenna integrally formed as part of a printed circuit board supported within the instrument cluster assembly.
